(19) United States
(12) Patent Application Publication
(10) Pub. No.: US 2010/0108642 A1
(43) Pub. Date: May 6, 2010

(54) METHOD FOR REMOVING FINE-GRAIN SILICON MATERIAL FROM GROUND SILICON MATERIAL AND APPARATUS FOR CARRYING OUT THE METHOD

(75) Inventors: Jörg Acker, Dresden (DE); Anja Rietig, Schipkau (DE); Birgit Meinel, Brieske (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Adensis GmbH, Dresden (DE)

(21) Appl. No.: 12/611,441

(22) Filed: Nov. 3, 2009

(30) Foreign Application Priority Data
Nov. 4, 2008 (DE) 10 2008 055 833.8

(51) Int. Cl. B44C 1/22; C23F 1/08

(52) U.S. Cl. 216/99; 156/345.11; 156/345.15

(57) ABSTRACT

A method and an apparatus for removing fine-grain silicon material from coarse-grain ground silicon material are disclosed. In the method, ground silicon material is selected that exhibits a predominantly brown color in an aqueous suspension, indicating that a considerable fraction of the ground silicon material has a grain size of less than 0.25 μm, and the ground silicon material is supplied to a reaction vessel. An aqueous or water-containing solution of a base is added to the ground silicon material, causing an etching process which chemically removes a fine fraction with a grain size of less than approximately 1 μm. Acid or water is then added to terminate etching and cause rapid sedimentation of a suspension in form of a relatively coarse-grain solid, which can be removed for further processing. The solution formed above the relatively coarse-grain solid can also be withdrawn.

### CROSS-REFERENCES TO RELATED APPLICATIONS

This application claims the priority of German Patent Application, Serial No. 10 2008 055 833.8, filed Nov. 4, 2008, pursuant to 35 U.S.C. 119(a)-(d), the content of which is incorporated herein by reference in its entirety as if fully set forth herein.

### BACKGROUND OF THE INVENTION

The present invention relates to a method for removing fine-grain silicon material, in particular with a grain size of less than 1 μm, from coarse-grain ground silicon material with a grain size of less than 500 μm. The present invention further relates to an apparatus for removing fine-grain silicon material with the method.

The following discussion of related art is provided to assist the reader in understanding the advantages of the invention, and is not to be construed as an admission that this related art is prior art to this invention.

Comminution processes produce a ground material with an inhomogeneous distribution of grain sizes independent of the way energy is introduced and independent of the technical conversion and the employed apparatus. Fine-grain fractions not only represent a loss of ground material; they may also have serious consequences for configuring a technical process. For example, fine-grain fractions can accumulate inside fittings (e.g., valves, faucets, pumps, etc.) and thereby impair their functionality or cause failure. Fine-grain particles can also rapidly clog filters and strainers.

Moreover, fine-grain materials in form of dust may represent a health risk and may cause an explosion. This includes silicon, which is very reactive in small grain sizes.

Comminution processes can also cause significant contamination of the ground material. This is caused by mechanical abrasion on the material of the employed apparatus, for example a ball mill or a crusher caused by the process. Abrasion is expected to increase with increasing milling time and with the hardness of the milled material.

When comminuting silicon, in particular the small grain sizes (smaller than 10 μm) and the smallest fractions (grain sizes in a range smaller than 0.25 μm) are undesirable, wherein the latter can be identified from their brown color. These can no longer be separated using dry screening processes, and are also challenging in other separation processes.

Typically, mechanical separation processes result in a ground material fraction which includes material with grain sizes from 0 μm to a grain size representing the largest size that can still be separated (comminuted) mechanically. This upper limit is between 1 and 50 μm, depending on the complexity of the process. The grain size is predominantly between 20 and 50 μm with dry screening processes. If the desired grain size fraction is smaller or an additional separation step in a range of less than 1 μm is to be performed, in order to separate for the aforementioned reasons the fraction of the very fine material, then a serious problem arises.

It would therefore be desirable and advantageous to address prior art shortcomings and to effectively remove in a relatively simple and cost-effective manner from a ground silicon material with grain sizes smaller than 500 μm a fine-grain silicon material (“fine-grain fraction”, “fine fraction” or “very fine fraction”), in particular material with grain sizes less than 1 μm, while allowing the use of less fine silicon material (“coarse-grain fraction”, “coarse fraction”) for further processing, without significant losses.

### SUMMARY OF THE INVENTION

According to one aspect of the present invention, a method for removing fine-grain silicon material with grain sizes of less than 1 μm from ground silicon material having grain sizes of less than 500 μm, includes the steps of selecting ground silicon material that exhibits a predominantly brown color in an aqueous suspension, indicating that a considerable fraction of the ground silicon material has a grain size of less than 0.25 μm, and supplying the ground silicon material to a reaction vessel. The method further includes adding an aqueous or water-containing solution of a base, for example, NaOH or KOH to the ground silicon material, causing an etching process which produces a significant volume of foam and chemically removes a fine fraction with a grain size of less than approximately 1 μm, and adding acid, for example HCl, or water to terminate etching and cause rapid sedimentation of a suspension in form of a relatively coarse-grain solid. The sedimented relatively coarse-grain solid is then provided for further processing, or a solution formed above the relatively coarse-grain solid is withdrawn, or both.

According to yet another aspect of the invention, an apparatus for removing fine-grain silicon material with grain sizes of less than 1 μm from ground silicon material having grain sizes of less than 500 μm includes a reaction vessel constructed by interconnecting a storage vessel for the ground silicon material, a storage vessel for a base or a aqueous or water-containing solution of a base, and a storage vessel for an acid, a controller for controllably supplying the ground silicon material, the base or the solution of the base and the acid to the reaction vessel, a device for agitating contents of the reaction vessel, a unit for interrupting supply of acid to the reaction vessel either at a time predetermined by a timer or at a time determined by a measuring device, a first withdrawal device installed on the reaction vessel for removing a sedimented fraction of a relatively coarse-grain solid, and a second withdrawal device installed on the reaction vessel for removing a liquid residing above the sedimented fraction.

The disclosed process operates by suspending and chemically dissolving the very fine fraction of the ground silicon material. Importantly, instead of acid, an aqueous or water-containing solution of a base, such as in particular NaOH and KOH, is used.

Hydrogen is produced when the surface of silicon is etched. As a result of this etching process, the entire suspension begins to move and foam, with small gas bubbles being released continuously. This foaming effect is very strong, in particular when silicon particles with grain sizes of approximately 0.25 μm or less are present. Ground silicon material produced with technical grinding processes frequently results in particles where up to 70% of the particles have grain sizes less than 100 μm, with a significant fraction thereof again having grain sizes of less than 0.25 μm. Accordingly, the preferred application of such ground material likewise produces a strong foaming effect. Such ground material of very fine grain size is also produced as waste material when silicon is processed (in the form of single pieces, such as blocks (e.g., ingots) or of discs, in particular during cutting, sawing, polishing, drilling). Such ground material is also commercially available.

The term “significant foaming” is to be understood here as an increase in volume of at least 10%. Under certain circumstances, this increase in volume can reach 100%. The level of the strongly foamed suspension will typically be at least 1-3 cm.

The aforementioned suspension can be agitated and transported without adding mechanical complexity.

It has been observed: the smallest silicon grains are completely dissolved due to their higher reactivity, whereas the larger grains are only slightly etched. If the reaction time is selected accordingly, then the fraction of the smallest grains is completely dissolved and hence removed from the ground material. In this way, a desired grain size distribution and a desired separation step can be implemented. In this way, coarser ground silicon material with a considerably reduced very fine grain fraction can be obtained for semiconductor production or solar cell manufacturing.

Advantageously, the quantity of the added base may be selected so that etching by the base is terminated after the base is completely consumed.

The reaction can be terminated by adding large quantities of water (dilution) or, more effectively, by adding acid up to the neutral point (neutralization) or into the acidic range. It has been observed that the remaining particles precipitate very quickly regardless of their size and that the solution above the sentiment is clear and free of smallest silicon particles, e.g., has grain sizes smaller than 1 μm. Importantly, the precipitated solid can be easily suspended by agitation, in order to be transported or to start another process.

The process takes advantage of the following fact: in a suspension of the ground silicon material, grains larger than about 0.25 μm have a black color. Conversely, silicon material with a grain size equal to or less than about 0.25 μm has a brown color. According to a preferred embodiment, the end of the etching process is determined or initiated by determining the color, preferably by determining the transparency or clarity.

Instead of interrupting the etching process by introducing acid from the acid storage vessel followed by neutralization, etching can also be interrupted by dilution through the introduction of water from a water storage vessel.

For this purpose, a device for measuring a clarity of a suspension residing in the reaction vessel may be provided. When this device indicates “clarity” or “transparency” of the suspension, the etching process is concluded, and additional steps (e.g., withdrawing the sedimented fraction and/or the liquid above) may follow.

Importantly, a safety device may be provided to prevent a level of a foamed suspension formed in the reaction vessel from rising above a maximally allowed level.

As described above, hydrogen is produced during foaming. The hydrogen should be carefully vented from the reaction vessel through an exit port.

According to another advantageous feature of the present invention, dedicated control valves may be provided for controlling the inflow of the ground silicon material, the base or the aqueous or water-containing solution of the base and the acid.

It should also be mentioned that in the semiconductor industry, in particular in the manufacture of solar cells, silicon material with a small particle size (less than approximately 1 μm) is undesirable. Instead, material with greater particle size, i.e. material that does not include very fine grains, is used in photovoltaic applications. Such coarser material can be produced cost-effectively with the disclosed method and the described apparatus from conventional, grainy silicon material or from the aforedescribed waste silicon generated during silicon processing. This represents a significant advantage.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIGS. 1-5 show schematic illustrations of a content of a vessel, after undergoing different process steps according to the present invention; and

FIG. 6 shows a schematic illustration of a device for removing very fine-grain silicon particles from a grainy ground silicon material.

### DETAILED DESCRIPTION OF PREFERRED EMBODIMENTS

Throughout all the Figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

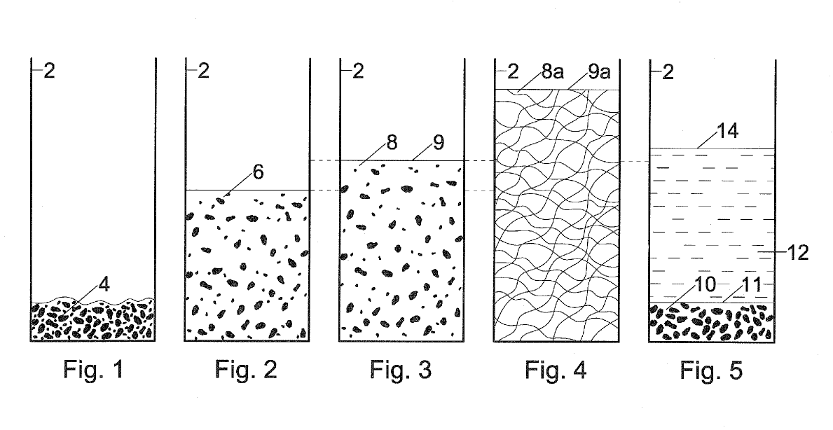

FIGS. 1 to 5 illustrate schematically a principle illustration of various process steps of a method according to the invention with reference to an exemplary embodiment. The described approach was successful in the laboratory, but can also be implemented on a commercial scale.

Turning now to the drawing, and in particular to FIG. 1, in a first step grainy ground silicon material 4 is introduced in a vessel 2. 3 kg mechanically ground, e.g., commercially available silicon with a fraction having a grain size smaller than 50 μm was used. The employed vessel 2 has a diameter of about 20 cm. The ground silicon material 4 contains about 5 wt.-% of fine-grain silicon with grain sizes below 0.25 μm. It should be noted that the vessel 2 in FIG. 1 contains only solid ground silicon material 4 with a “fine fraction” and a “coarse fraction.” The fine fraction is to be removed without causing a noticeable loss of the silicon coarse fraction.

In a second step, the silicon coarse fraction 4 is mixed with about 2.3 l deionized water H₂O and suspended by stirring. The suspension 6, shown in FIG. 2, has a brown color produced by the fine fraction of the ground silicon material 4, in particular by a fraction with a grain size of less than 0.25 μm.

In a third step, a base, in particular about 0.2 l of a NaOH solution with 4.4 wt.-%, is added immediately thereafter, while the silicon is further suspended by stirring. This suspension is indicated with the reference symbol 8. In this described exemplary embodiment the resulting base concentration was about 0.05 wt.-%.

It should be mentioned that the second and third step can also be combined.

This suspension 8 undergoes an immediate chemical reaction, as evidenced by heat generation, bubble formation and significant foaming, with foaming illustrated in FIG. 4. The foamed product, which now fills almost the entire vessel 2, is indicated with the reference symbol 8a. As can be clearly seen, the surface 9a is located significantly above the surface 9 of FIG. 3, with the height of this surface 9 being determined by the sum of the volumes of Si, H₂O and NaOH. Depending on the base concentration and the dimensions of the vessel, the surface 9a can rise above the height of the surface 9 by, for example, 3-4 cm or even more, for example 20 cm.

Advantageously, the foamed suspension 8a is constantly agitated during the foaming process to prevent excess foaming. However, other safety measures can also be implemented to guarantee that a maximum level 9a is not exceeded.

As shown in FIG. 4, etching may occur during foaming, which is maintained for about one hour. The fine material, preferably also the silicon particles with a particle size of less than 0.25 μm, are then practically completely dissolved. Strong foaming is also important for the production of the desired coarse material which is substantially free of fine material, in particular of silicon material with a grain size of less than about 0.25 μm to 1 μm. Foaming causes the particles to swirl, which enhances the chemical attack on the individual particles.

In a subsequent fourth step, the foamed solution 8a is neutralized by adding acid, in the present example particularly by adding of about 40 ml HCl with 36 wt.-%. This stops the etching process. Alternatively, large quantity of water H₂O could also be added. The foam 8a diminishes, with the remaining coarser ground material 10 completely precipitating within several minutes, as shown in FIG. 5. A clear (not brown) liquid or solution 12 is formed above the boundary 11 of the precipitated (sedimented) coarse-grain ground material 10. The previously existing fine-grain ground material, shown in FIG. 1, is dissolved in this clear solution 12. The surface 14 of the liquid 10 is located somewhat below the surface 9a of the foamed material 8a.

The clear solution 12, which contains almost no particulate matter, can now be separated and withdrawn from the vessel 2.

The precipitated coarse-grain silicon 10 can now be likewise removed from the vessel 2 and a) treated again with the aforementioned steps 1 to 4 or b) transferred for further processing, e.g., rinsing, water absorption, drying. As mentioned above, the coarse-grain silicon material 10 is important, for example, for semiconductor and solar cell manufacturing.

The following observation was made in the aforementioned exemplary process: if a sample of precipitated ground material 10 is placed on a fine-mesh filter (pore diameter less than 1 μm) and water is added to this sample, then the rinse solution passing through the filter shows no brown coloration. The fine-mesh filter also does not become clogged.

It has also been observed that renewed precipitation of this separated coarse-grain fraction 10 in water (according to FIG. 2) or in an acidic medium even after many hours does no longer show a brown discoloration. Instead, the remaining silicon 10 precipitates with a clear boundary, so that a predominantly clear solution remains in the upper region. As indicated by the (non-brown) color, the fine fraction of silicon is—as desired—completely removed.

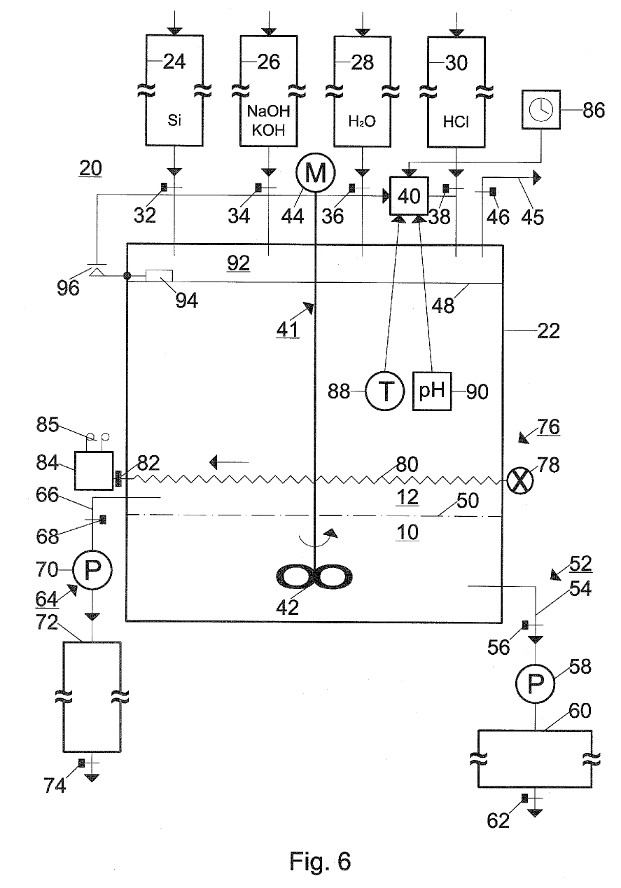

FIG. 6 shows an apparatus 20 for removing very fine silicon particles from grainy ground silicon material 4, using the process described above with reference to FIGS. 1 to 5.

The core component of the apparatus 20 is a reaction vessel 22, to which storage vessels 24, 26, 28 and 30 for dry ground silicon material Si, sodium or potassium base NaOH and KOH, respectively, water H₂O or an acid, such as for example hydrochloric acid HCl, are connected. Controllable throttle or shutoff devices 32, 34, 36 and 38, depicted here as throttle or shutoff valves, are located in the supply lines between the storage vessels 24, 26, 28, 30 and the reaction vessel 22. These shutoff devices 32 to 38 can be operated either manually or electrically and are used to control the corresponding supply into the reaction vessel 22. The two storage vessels 26, 28 can also be combined into a single storage container (not illustrated), which then contains a base diluted with water.

The ground silicon material 4 contains once more a significant fraction of silicon dust with a particle size or grain size of about 0.25 μm or less.

The individual shutoff devices 32 to 38 can be individually or commonly associated with a control device. Such control device 40 is illustrated on the shutoff device 38 for acid supplied from the storage vessel 30.

A device 41 is centrally provided for agitating the content of the reaction vessel 22. In the present example, an agitator with a blade 42 is used, which is rotated by an electric motor 44. In principle, a different device 41 can be used for agitation, for example a device operating based on an electric-inductive principle.

An outlet 45 with a shutoff valve 46 is located on the upper end of the reaction vessel 22. The hydrogen H₂ produced by the reaction 10 here be vented.

The uppermost level of the level in the vessel 22 is indicated by the reference symbol 48. This level 48 is located considerably higher, for example by of up to 100%, than the level which, as illustrated in FIG. 4, corresponds to the sum of the non-foamed volumes of Si, H₂O, and NaOH. Safety measures have been adopted to ensure that this uppermost level 48 is not exceeded during foaming. The boundary of the sedimentation, which according to FIG. 5 separates the coarse-grain silicon 10 from the clear liquid 12 above, is indicated with the reference symbol 50.

A withdrawal device 52 is arranged at the lower end of the storage container 22 for removing the coarse fraction 10 desired for further processing (which is used in the field of semiconductor technology, for example, for producing silicon wafers). The withdrawal device 52 is indicated as withdrawal line 54 with a shutoff valve 56 and a conveying device or pump 58. It will be understood that any type of withdrawal device 52 can be employed for the coarse-grain material 10. It should also be mentioned that the particles of the coarse fraction 10 rarely adhere to one another or stick to the bottom of the reaction vessel 22, which would prevent them from being dissolved. The withdrawal device 52 conveys the coarse-grain ground material 10 as needed to a container and/or a rinse and/or drying device 60. From there the material 10 can be transferred via a shutoff valve 62 to an (unillustrated) receiving vessel.

Likewise, a withdrawal device 64 is provided for removing the clear liquid 12, which is also illustrated as withdrawal lines 66 with shutoff valve 68 and conveying device or pump 70. This withdrawal device 64 transfers the clear liquid 12 (which contains in solution the fine-grain ground silicon material) to a catch vessel 72 commensurate with the process requirements. The liquid 12 can then be removed via a drain or shutoff valve 74 or transferred for recycling.

A device 76 for measuring the clarity of the upper part of the full suspension 8a (see FIG. 4) after introduction of the acid from the storage container 30 may be added for improving the operation of the device 20. The device 76 can be used to determine when the precipitation of the coarse-grain fraction 10 is concluded and when this fraction 10 and the liquid 12 residing above the boundary 50 can be removed. The device 76 in the present example includes a light source 78, which projects light 80, after the light 80 has passed a filter 82, through the liquid 12 onto a light detector 84 slightly above the expected boundary 50. A signal generated at the output terminals 85 of the light detector 84 is transmitted, for example, to the control device 40 if the clarity is adequate. The control device 40 then interrupts or reduces the flow of acid from the storage container 30.

Instead of this special device 76, a device can also be used which indicates when a desired grain size distribution in the reaction vessel 22 is obtained. For example, a device for online monitoring of the average grain size can be used, which may, however, add complexity.

If the parameters of the process are known, then a clock or an adjustable timer 86, which after a predetermined time, for example of 30 or 60 minutes depending on the process, interrupts or reduces supply of acid via the control device 40, can also be used for interrupting the supply of acid. Alternatively, H₂O can also be introduced into the storage vessel 22 through control by the timer 86 to interrupt etching by the base NaOH or KOH (dilution).

A temperature value T measured by a temperature sensor 88 or a pH-value measured by a pH transducer 90 can also be used to determine the time of the interruption or reduction. The temperature T and the pH value are indicative of the condition of the suspension. Supply of acid can then be interrupted, as desired or according to the setting, when the measured pH value indicates “neutral” or “acidic.”

In the present embodiment, a safety device 92 is arranged in the upper part of the reaction vessel 72 which is used to prevent excessive foaming which would cause the predetermined uppermost level 48 to be exceeded. In the example illustrated in FIG. 6, the safety device 92 is implemented as a fill level indicator with a float 94 which interrupts an electrical contact path 96 as soon as the float 94 rises to the uppermost level 48 on the foamed suspension 8a. This interruption operates electrically on the control device 40 via a control line.

Advantageously, with the illustrated apparatus 20, the undesired, very small particles can be effectively separated and cost-effectively removed from ground silicon material, so that the still quite small, but comparatively larger particles (e.g., greater than 1 μm) which are desired for processing (for example in the semiconductor industry, in particular as raw material for solar cell production), can be obtained for further processing without the presence of very fine silicon dust. The process- and health-related disadvantages mentioned at the beginning are hereby eliminated.

In summary, the described process and apparatus for carrying out the process are designed particularly for chemical dissolution of very fine silicon particles with a grain size of 1 μm or less by
using the aqueous or water-containing solution of the base (e.g., NaOH or KOH),
strong foam formation,
particularly using silicon material that forms a brown-colored suspension.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method for removing fine-grain silicon material with grain sizes of less than 1 μm from ground silicon material having grain sizes of less than 500 μm, said method comprising the steps of:
selecting ground silicon material that exhibits a predominantly brown color in an aqueous suspension, indicating that a considerable fraction of the ground silicon material has a grain size of less than 0.25 μm,
supplying the ground silicon material to a reaction vessel,
adding an aqueous or water-containing solution of a base to the ground silicon material, causing an etching process which produces a significant volume of foam and chemically removes a fine fraction with a grain size of less than approximately 1 μm,
adding an acid or water to terminate etching and cause rapid sedimentation of a suspension in form of a relatively coarse-grain solid, and
providing the sedimented relatively coarse-grain solid for further processing or withdrawing a solution formed above the relatively coarse-grain solid, or both.

2. The method according to claim 1, wherein the base is selected from NaOH and KOH.

3. The method according to claim 1, wherein the acid is hydrochloric acid (HCl).

4. The method according to claim 1, wherein a quantity of the added base is selected so that etching by the base is terminated after the base is completely consumed.

5. The method according to claim 1, wherein the aqueous or water-containing solution of the base is NaOH-H₂O or KOH-H₂O.

6. The method according to claim 3, wherein the hydrochloric acid (HCl) is used for neutralization or for termination of etching.

7. The method according to claim 1, wherein termination of etching is determined from a color, transparency or clarity, or a combination thereof, of the solution formed above the relatively coarse-grain solid.

8. The method according to claim 1, wherein an etching time is set so that preferably material with a grain size of less than 0.5 μm is removed.

9. The method according to claim 1, wherein an etching time is set so that material with a grain size of less than 0.1 μm is removed.

10. An apparatus for removing fine-grain silicon material with grain sizes of less than 1 μm from ground silicon material having grain sizes of less than 500 μm, comprising:
a reaction vessel constructed by interconnecting a storage vessel for the ground silicon material, a storage vessel for a base or a aqueous or water-containing solution of a base, and a storage vessel for an acid,
a controller for controllably supplying the ground silicon material, the base or the solution of the base and the acid to the reaction vessel,
a device for agitating contents of the reaction vessel,
a unit for interrupting supply of acid to the reaction vessel either at a time predetermined by a timer or at a time determined by a measuring device,
a first withdrawal device installed on the reaction vessel for removing a sedimented fraction of a relatively coarse-grain solid, and
a second withdrawal device installed on the reaction vessel for removing a liquid residing above the sedimented fraction.

11. The apparatus according to claim 10, further comprising a device for measuring a clarity of a suspension residing in the reaction vessel.

12. The apparatus according to claim 10, further comprising a safety device which prevents a level of a foamed suspension formed in the reaction vessel to rise above a maximally allowed level.

13. The apparatus according to claim 10, wherein the reaction vessel further comprises an exit port for hydrogen.

14. The apparatus according to claim 10, further comprising dedicated control valves for controlling inflow of the ground silicon material, the base or the aqueous or water-containing solution of the base and the acid.

15. The apparatus according to claim 10, wherein the device for measuring the clarity comprises a light source and a light detector.

16. The apparatus according to claim 10, wherein the unit for interrupting the supply of acid comprises a temperature transducer or a pH-value transducer.

17. The apparatus according to claim 10, further comprising a rinsing or drying device connected to the first withdrawal device for the sedimented fraction.

18. The apparatus according to claim 10, further comprising a catch vessel connected to the second withdrawal device for the liquid.

19. The apparatus according to claim 10, wherein the device for agitating comprises an agitator connected to an electric motor.

20. The apparatus according to claim 12, wherein the safety device comprises a float which floats on a surface of a suspension or a timer.

21. The apparatus according to claim 10, wherein the ground silicon material and a concentration and quantity of the aqueous or water-containing solution of the base supplied to the reaction vessel so that a level of a foamed suspension above a surface of a non-foamed suspension plus the base is at least 1 to 3 cm.

22. The apparatus according to claim 21, wherein the level of the foamed suspension above the surface of the non-foamed suspension plus the base is greater than 10 cm.

23. The apparatus according to claim 10, wherein the base is selected from NaOH and KOH.

24. The apparatus according to claim 10, wherein the acid is hydrochloric acid (HCl).
